(19) United States
(12) Patent Application Publication
(10) Pub. No.: US 2008/0189310 A1
(43) Pub. Date: Aug. 7, 2008

(54) Method for Encoding an Xml-Based Document

(75) Inventors: Jorg Heuer, Oberhaching (DE); Andreas Hutter, Munchen (DE); Uwe Rauschenbach, Poing (DE)

Correspondence Address: STAAS & HALSEY LLP, SUITE 700, 1201 NEW YORK AVENUE, N.W., WASHINGTON, DC, 20005, US

(73) Assignee: SIEMENS AG, Munchen (DE)

(21) Appl. No.: 11/662,057

(22) PCT Filed: Aug. 30, 2005
(86) PCT No.: PCT/EP2005/054255

§ 371 Date: Feb. 19, 2008

(30) Foreign Application Priority Data
Sep. 7, 2004 (DE) 10 2004 043 269.4

(51) Int. Cl. G06F 17/30

(52) U.S. Cl. 707/101; 707/E17.009

(57) ABSTRACT

The root element of an encoded fragment is stored in a table by name and the name of a parent element, i.e., according to their paths. The path is an absolute path which starts at the root node of the document tree and leads to an element of the document tree which is exclusively contained in a fragment, i.e., which is the root element of an encoded fragment. This table, the so-called context path table, is transmitted in advance to initialize a decoder. The encoder and decoder associate every entry of the context path table with a context code of a defined length. Before an encoded fragment is transmitted, the absolute path to the root element of the fragment is signaled as the context information by the ContextCode associated therewith. This ContextCode has a defined length for the period of transmission. The use of an initialization table allows free selection of the subdivision into fragments during initialization of transmission.

### CROSS REFERENCE TO RELATED APPLICATIONS

This application is based on and hereby claims priority to German Application No. 10 2004 043 269.4 filed on Sep. 7, 2004, the contents of which are hereby incorporated by reference.

### BACKGROUND

A method for encoding an XML-based document and a corresponding decoding method, as well as corresponding encoding and decoding apparatuses are described below.

XML (Extensible Markup Language) is a language which allows a structured description of the contents of a document. In this situation, name spaces may be used, which are defined by XML scheme language definitions. A more accurate description of the XML scheme and of the structures, data types and content models used therein can be found in TR/2001/REC-xmlschema-0-20010502, TR/2001/REC-xmlschema-1-20010502 and TR/2001/REC-xmlschema-2-20010502 from w3.org.

The related art discloses methods for encoding XML-based documents in which the document is converted into an encoded binary representation. By way of example, documents ISO/IEC 15938-1 Multimedia Content Description Interface—Part 1: Systems, Geneva 2002 and ISO/IEC 15938-1:2002/FDAM 1:2004 Multimedia Content Description Interface—Part 1: Systems, Amendment 1: Systems Extensions, which were produced during the development of an MPEG-7 encoding standard, describe methods for encoding and decoding XML-based documents. In this situation, fragments of the XML-based document can be encoded into what are known as Fragment Update Units.

It is frequently necessary to categorize Fragment Update Units on the basis of their content and to store them, for example with such categorization, in tables. This allows fragments in a category to be quickly retrieved when required and to be presented, for example. In this situation, it is advantageous if the categorization requires little computation complexity, since the categorization needs to be performed during reception without specific retrieval besides other tasks of a receiver. By way of example, besides reception, decoding and indication of a broadcast radio transmission, XML fragments are also received which contain program-accompanying information and are quick to categorize. In this situation, it is advantageous if the context information which is used to categorize the fragments is of fixed length, since this can then be read and compared for the categorization with little complexity.

The methods known from the related art for producing a binary representation of XML-based documents have drawbacks with the fast categorization of received fragments. The related art contains methods for signaling context information for the fragments ETSI TS 102 822-3-2: Broadcast and On-line Services: Search, select and rightful use of content on personal storage systems (“TV-Anytime Phase 1”), Part 3: Metadata, Sub-part 2: System Aspects in a Unidirectional Environment and DVB GBS0005r16: Carriage of TVA information in DVB TSs. However, these have the drawback that context information is either variable in length and inefficient with a small number of different fragments, as described in or is a fixed length but limited to fragments predefined in a standard, as described in DVB GBS0005r16: Carriage of TVA information in DVB TSs.

The problem of categorizing of fragments arises with a document which is created using XML language (XML=Extensible Markup Language) and which is represented in a binary format specified on the basis of the MPEG7 standard, what is known as MPEG7-BiM format, for example. With regard to the MPEG7-BiM format of an XML document, reference is made particularly to documents ISO/IEC 15938-1 Multimedia Content Description Interface—Part 1: Systems and ISO/IEC 15938-1:2002/FDAM 1:2004 Multimedia Content Description Interface—Part 1: Systems, Amendment 1: Systems Extensions.

Such representation involves a data stream being produced which is split into a plurality of units (Access Units), which for their part in turn include a plurality of fragments, the aforementioned Fragment Update Units. The units are encoded and, when needed, are sent as an MPEG7-BiM stream to one or more receivers. In this case, the fragments contain context information which is represented with a different number of bits, depending on the fragment content.

The possible fragment content is in this case not limited to a subset of the XML elements which are to be transmitted.

Within the context of TV Anytime (TVA)—a concept which, on the basis of a combination of interactive services such as the Internet with the traditional broadcast such as television, allows a television viewer to view his television program at any desired time, and which is described in more detail in DVB GBS0005r16: Carriage of TVA information in DVB TSs, to which reference is made—a limited number of possible fragment contents is stipulated.

In this case, the volume of possible XML elements in an XML document is stipulated by a name space in DVB GBS0005r16: Carriage of TVA information in DVB TSs, to which reference is made. In addition, the contents of fragments are stipulated as a subset of these XML elements. In this case, the signaling of the context information for these fragments is specified by a code of fixed length. This allows efficient categorization of the received fragments, but the fragmentation is limited to the specified fragment contents. If new information elements need to be transmitted then this is not possible without reallocating codes.

### SUMMARY

An aspect is to provide a method for encoding and a method for decoding XML-based documents and a corresponding encoding and decoding device which allows improved categorization of fragments in the encoded data stream without restricting the volume of possible fragment contents and allows efficient encoding of the context information.

One advantage which is fundamental is that the categorization can take place more quickly than is the case with methods based on the related art. In this case, this is advantageously achieved without restricting the volume of possible fragments. In addition, this also allows efficient encoding of the context information.

Also described is a method for decoding a data structure, where a data structure encoded using the encoding method described above is decoded.

Also described is a method for encoding and decoding a data structure using the encoding method and decoding method described above.

Also described is an encoding apparatus which can be used to carry out the encoding method, and also a decoding apparatus which can be used to carry out the decoding method. In addition, a corresponding encoding and decoding apparatus is described which can be used to carry out the combined encoding and decoding method described above.

In structured documents, particularly XML documents, the type of information in an XML element or XML attribute of a document is declared by the names of all the father elements and their types. In this situation, the XML elements and XML attributes are arranged in a document tree on the basis of a structured definition.

In the described method for encoding the structured document, all the XML elements, which are root elements of an encoded fragment, are stored in a table according to their name and the name of their father elements, that is to say according to their path. The paths are absolute paths which start at the root node of the document structure tree and lead to an element of the document structure tree which is exclusively contained in a fragment, that is to say a root element of an encoded fragment. This table, called a context path table, is transmitted in advance in order to initialize the decoder. The encoder and decoder associates a context code (ContextCode) of fixed length with every entry in the context path table. Before an encoded fragment is transmitted, the absolute path to the root element of the fragment is signaled as context information by the associated ContextCode. This ContextCode has a fixed length for a transmission. The use of an initialization table allows free selection of the split into fragments during initialization of the transmission, however.

In a further embodiment, the paths are stored in a table and transmitted relative to the preceding path. This allows a reduction in the storage complexity for the table.

In one particularly preferred embodiment, the paths are stored in the table and transmitted in line with the context path (ContextPath) encoding of the MPEG-7 BiM format as described in ISO/IEC 15938-1 Multimedia Content Description Interface—Part 1: Systems and ISO/IEC 15938-1:2002/FDAM 1:2004 Multimedia Content Description Interface—Part 1: Systems, Amendment 1: Systems Extensions. This allows the use of a standardized, widely used structure and a further increase in the reduction in the storage complexity.

If the length of the ContextCodes which is to be associated is signaled explicitly with the context path table, this allows new context paths to be included in the table for a sufficiently large selected length of the context codes during the transmission without altering the length and association of the context codes.

In one preferred embodiment, the context path tables are stored and transmitted repeatedly in the data stream. In this case, the length of the context codes is signaled by variable length codes, for example using variable length unsigned integer most significant bit first “vluimsbf”, as defined in ISO/IEC 15938-1 Multimedia Content Description Interface—Part 1: Systems and ISO/IEC 15938-1:2002/FDAM 1:2004 Multimedia Content Description Interface—Part 1: Systems, Amendment 1: Systems Extensions. This allows receivers dialing into a transmission to categorize fragments immediately and to associate context paths as soon as a context path table is received.

### Updates for the Code Length and for the Code Table.

In one preferred embodiment, the context path table only transmits context paths which contain paths to root elements of previously transmitted fragments and fragments which are to be transmitted before the next transmission of the context path table. If there are new paths to root elements of fragments, the context path table is expanded. This method is particularly advantageous for repeated transmission of context path tables, since the context path table only contains necessary information hitherto. This context path table is therefore smaller than those containing paths of all the root elements of fragments of the entire transmission. If the context paths which the context path table contains are not associated with successive context codes then the associated context code needs to be encoded in the context path table in addition to the respective context path.

### BRIEF DESCRIPTION OF THE DRAWINGS

These and other objects and advantages will become more apparent and more readily appreciated from the following description of the exemplary embodiments, taken in conjunction with the accompanying drawings of which:

FIG. 1A is text of an XML document structured on the basis of the related art;

FIG. 1B is a tree diagram for a representation of the structured XML document tree which is known from the related art;

FIG. 1C is a tree diagram split into fragments for the tree which is known from the related art;

FIG. 1D is a data structure of a data stream of Access Units and fragments which comes from the related art;

FIG. 2 is a data structure for the data stream after a structured XML document has been encoded using the encoding method;

FIG. 3 is a data structure for a context path table;

FIG. 4 is a data structure for a context path table with explicit signaling of the fixed ContextCode length;

FIG. 5 is a data structure for a context path table update; and

FIG. 6 is a data structure for an expansion of a context path table.

### DETAILED DESCRIPTION OF THE PREFERRED EMBODIMENT

Reference will now be made in detail to the preferred embodiments, examples of which are illustrated in the accompanying drawings, wherein like reference numerals refer to like elements throughout.

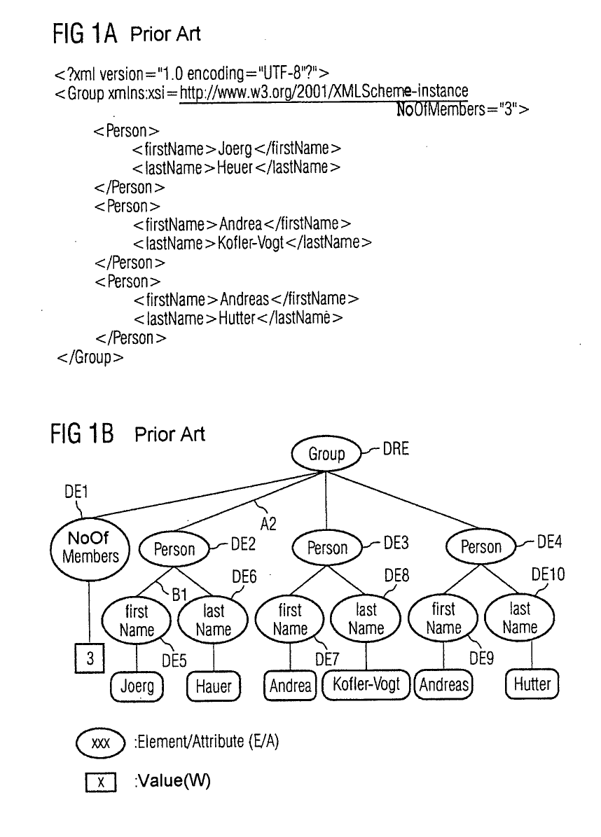

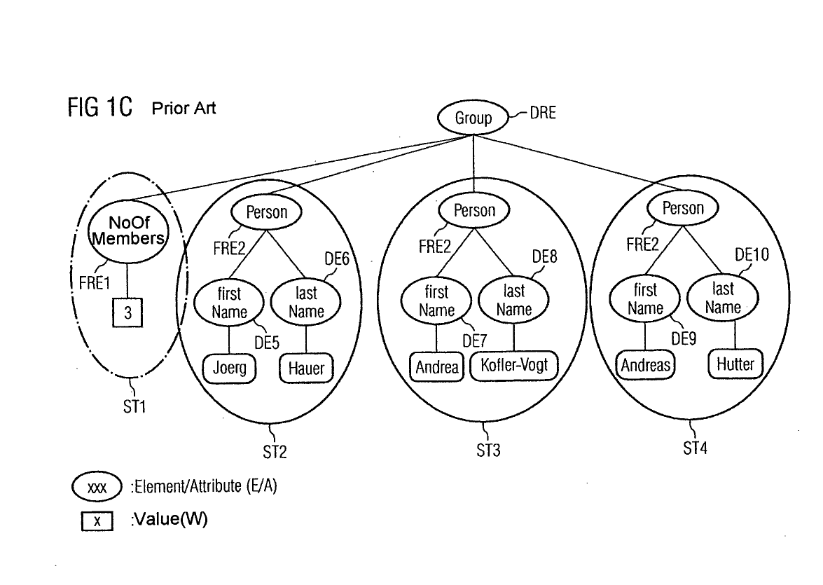

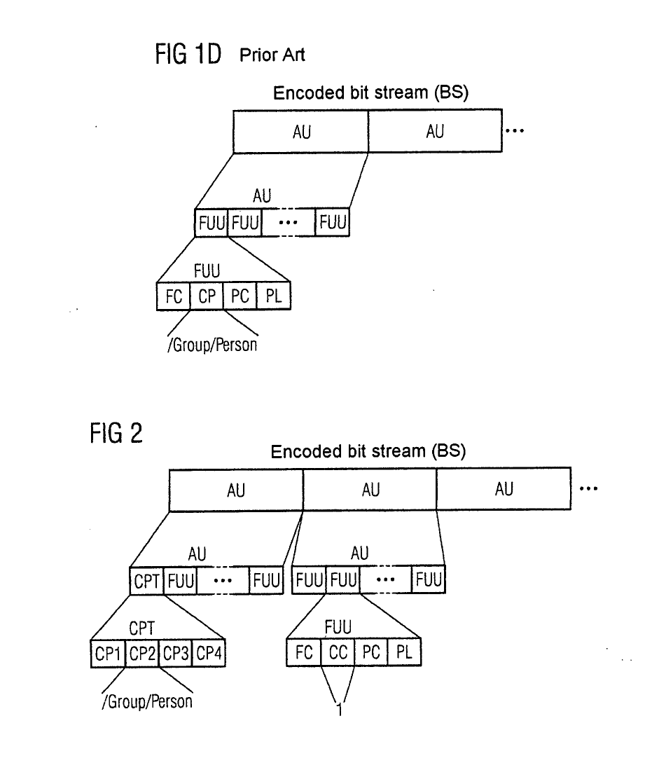

FIG. 1A shows a structured XML document in text form which is known from the related art. It can be seen here that combined structure elements—also just called elements for simplicity—identified by angle brackets have, in some cases, further structure elements and data (value forms), chosen by way of example for this illustration, embedded between them. To this end, the structure elements, also called tags, are in some cases in the form of a pair of a start tag and an end tag, the end tag differing from the start tag only in that it has an oblique stroke after the angle bracket.

In addition, such embedded data or structure elements can also exist in parallel with one another.

The resultant structure in this case is difficult to present in text form from a certain size onward. On the basis of the resultant structure, it is therefore known practice to show a document structured in this way as a tree structure.

FIG. 1B shows the structured XML document known from FIG. 1A in the tree representation. In this case, the structure elements or pairs of structure elements respectively produce an element or node of the document shown as an ellipse, and when an element contains a further element—that is to say embeds it—a path runs from a node directly to a new node, whereas when the element embeds data directly—that is to say contains a value—a path from a node opens out directly into a value form shown as a rectangle.

Starting from a root node DRE of the document, every node DE1 . . . DE10 can thus be determined or described by an absolute path routed to it. By way of example, the node DE5 is determined by the path resulting from steps A2 and B1.

Taking the tree structure shown as a starting point, the tree representation shown in FIG. 1B is now partitioned as shown in FIG. 1C given the usual fragmentation as described above. In this case, the tree structure is divided into subtrees ST1 . . . ST4 which represent the fragments of the XML document.

This division produces a root element or node FRE1 . . . FRE4 of the respective fragment (subtree) ST1 . . . ST4, which in turn opens out either into remaining elements DE5 . . . DE10 or into value forms, for each subtree ST1 . . . ST4 from a respective one of the elements DE1 . . . DE10 which is exclusively contained in a subtree ST1 . . . ST4.

this case, the subtrees ST1 . . . ST4 can be identified by paths to the root elements FRE1 . . . FRE4 of the subtrees in similar fashion to the method described above.

For transmission, such a document is now normally encoded. This usually produces a (bit) data stream. FIG. 1D shows the structure of an encoded data stream BS as shown on the basis of a specified representation known from the related art.

In this representation, the data stream is divided into Access Units AU which include a plurality of fragments FUU. In this case, the fragments FUU represent subtrees of an XML document, in line with FIG. 1B. The fragments FUU are represented by a Fragment Command (FC), by a Context Path (CP) and Position Codes for the root element FRE1 . . . FRE4 of a subtree and by a representation of the subtree (PL).

By way of example, a context path (ContextPath) CP is represented on the basis of an XPATH notation which is known from the related art, as described by www.w3.org/TR/xpath, and which is obtained from an array, separated by oblique strokes, of the names of a predecessor node (also father node) for its succeeding node(s) (also successor or child node).

In this case, the context path can identify every XML element or attribute of a name space declared in the instance. Normally, however, it is only appropriate to use particular elements or attributes as a root element of a subtree for representing a fragment FUU for a transmission. In addition, context paths with codes of variable length similar to the length of a context path are represented using the XPATH notation. This has drawbacks as described above, however.

Encoding based on the described method provides a way of allowing efficient encoding with context codes of fixed length in the fragments FUU particularly when there are a plurality of fragments with the same context path.

FIG. 2 shows a structure for a data stream, representing the encoded XML document, which has been created using the described method. It can be seen that the stream contains not only fragments FUU at the start of the transmission but also a context path table CPT which contains a list of context paths CP1 . . . CP4.

According to the number of entries, the bit length of the context codes CC is determined, which remains constant for the duration of a transmission to a decoder, so that all the entries can be clearly identified. Usually, the bit length is chosen to be (CC)>=1d (number of entries), where 1d is the logarithm base two. The root nodes of the subtrees are signaled in the respective fragments by the value of the context codes CC, which refers to entries in the context path table CPT, which contains the context path CP1 . . . CP4 to the root node.

In the example shown in FIG. 2, the value “1” identifies the second entry in the context path table CPT, since “0” identifies the first entry.

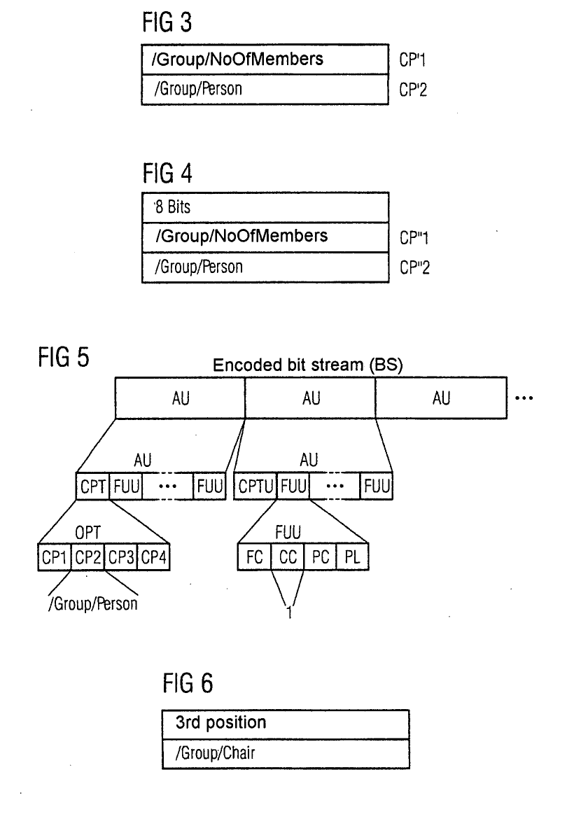

FIG. 3 shows an example of a context path table for the partitioning shown in FIG. 1C. The table contains two encoded addressable context paths CP′1, CP′2. Accordingly, the context code can be encoded with the calculation indicated above using one bit: 0 signals the first context path, 1 the second.

FIG. 4 shows an alternative exemplary embodiment of a context path table in which the number of bits (8) used to encode the context code is explicitly encoded in the data stream—that is to say a signal to the decoder. This is particularly advantageous when, during the transmission, the context path table needs to be expanded with further context paths. This is particularly necessary for methods for encoding XML documents in which, at the start of the encoding, the complete XML document is not yet available and hence all the context paths for the root elements of subtrees are not yet known.

FIG. 5 shows the structure of a data stream created using a method in which a first context path table CPT has been encoded at the start of the data stream and an expansion or update of the context path table CPTU has been encoded in the data stream later.

FIG. 6 shows a further exemplary embodiment, for an expansion of a context path table CPTU which contains information regarding the position (3) at which the subsequent new context paths (/Group/Chair) are entered in the context path table.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-20. (canceled)

21. A method for encoding a structured XML-based document in which structuring is carried out based on elements describing data in the document, comprising:
embedding document data into descriptive elements starting from a first descriptive element and including predecessor elements, each successively embedding successor elements, the successor elements capable of embedding further elements, where paths of the descriptive elements can be respectively determined starting with a first path of the first descriptive element and continuing with the predecessor elements leading up to the first descriptive element, and where the document data and the descriptive elements of the document are split into subsets, each subset containing at least one second descriptive element which has no predecessor element within the subset;
ascertaining the first path to form a first relation information item for each second descriptive element;
producing an explicit association information item to form a second relation information item for each ascertained path;
encoding at least the first relation information item for recognition by a decoder during an initialization process on the decoder; and
encoding the subsets with respectively associated association information items to enable the decoder to use the first relation information item and the second relation information item as a basis for ascertaining an associated ascertained path for the at least one second descriptive element in each subset.

22. The method as claimed in claim 21, further comprising encoding the second relation information item to enable the decoder to determine the second relation information item during the initialization process on the decoder.

23. The method as claimed in claim 22, further comprising encoding each association information item to be represented by a constant number of encoding units.

24. The method as claimed in claim 23, wherein said encoding of the first relation information item takes place after said ascertaining and includes organizing first paths in a first table.

25. The method as claimed in claim 23, wherein said encoding of the second relation information item includes forming a second table associating the first paths and respective association information items.

26. The method as claimed in claim 25, wherein the first table and the second table are organized in a combined table.

27. The method as claimed in claim 26, further comprising at least temporarily storing at least one of the first table and the second table.

28. The method as claimed in claim 27, wherein at least one of the first table and the second table are organized such that ascertained paths are at least in some cases represented relative to preceding paths.

29. The method as claimed in claim 28, wherein said encoding is based on MPEG-7 standard or a derivative thereof.

30. The method as claimed in claim 28, wherein said encoding of the first relation information item is based on a binary format defined by MPEG-7 standard or a derivative thereof.

31. The method as claimed in claim 30, wherein the paths in the first relation information item are encoded based on a ContextPath encoding defined by the MPEG-7 standard.

32. The method as claimed in claim 28, wherein said encoding of the association information item is based on a format defined by the MPEG-7 standard or a derivative thereof.

33. The method as claimed in claim 28, wherein the constant number of encoding units for each association information item produced by said encoding thereof can be determined by the decoder.

34. The method as claimed in claim 28, wherein said encoding of the first relation information item is performed repeatedly.

35. The method as claimed in claim 22, wherein said encoding of each association information item uses a variable number of encoding units.

36. The method as claimed in claim 35, wherein said encoding of the first relation information item is performed repeatedly and only first paths which have already been transmitted can be determined by the decoder.

37. The method as claimed in claim 36, further comprising encoding at least one of an updated first relation information item in the document and an expansion of the first relation information item in the document using an already encoded first relation information item.

38. A method for decoding a structured XML-based document encoded using the method as claimed in claim 21.

39. An encoding apparatus for encoding a structured XML-based document in which structuring is carried out based on elements describing data in the document, comprising:
means for embedding document data into descriptive elements starting from a first descriptive element and including predecessor elements, each successively embedding successor elements, the successor elements capable of embedding further elements, where paths of the descriptive elements can be respectively determined starting with a first path of the first descriptive element and continuing with the predecessor elements leading up to the first descriptive element, and where the document data and the descriptive elements of the document are split into subsets, each subset containing at least one second descriptive element which has no predecessor element within the subset;
means for ascertaining the first path to form a first relation information item for each second descriptive element;
means for producing an explicit association information item to form a second relation information item for each ascertained path;
means for encoding at least the first relation information item for recognition by a decoder during an initialization process on the decoder; and
means for encoding the subsets with respectively associated association information items to enable the decoder to use the first relation information item and the second relation information item as a basis for ascertaining an associated ascertained path for the at least one second descriptive element in each subset.

40. A decoding apparatus for decoding method a structured XML-based document encoded as claimed in claim 21.
